(19) United States
(12) Patent Application Publication
(10) Pub. No.: US 2003/0182647 A1
(43) Pub. Date: Sep. 25, 2003

(54) Automatic interactive component placement for electronics-CAD software through the use of force simulations

(76) Inventor: Mattias Dan Radeskog, Stockholm (SE)

Correspondence Address: Mattias Radeskog, Storbergsgatan 5, Hagersten, Stockholm, 129 42, SE

(21) Appl. No.: 10/100,695

(22) Filed: Mar. 19, 2002

(51) Int. Cl. G06F 17/50; G06F 9/45

(52) U.S. Cl. 716/8

(57) ABSTRACT

The method means that CAD software running an interactive force simulation is used for automation purposes when placing components on a circuit area. What makes this method novel is that it is a force simulation of a dynamic component placement where all the components move around the circuit area simultaneously, and that it is possible to interact with the simulation, make changes and control parameters that affect the results during run-time. Furthermore, it is remarkably easy for the user to understand how the simulation works.

### CROSS-REFERENCE TO RELATED APPLIACTIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The two major parts of the design work for electronic devices are component placement and routing. The work can be done either by hand or automation. My method based on rubber band force simulations is for the component placement part, and it can be used both for printed circuit boards (PCBs) and integrated circuits (ICs).

Electronic devices consist of smaller parts (components) that need to be interconnected in an appropriate way for the device to work properly. The straight line between two points that need to be interconnected is usually referred to as a rubber band. In most cases to goal is to find a placement where these rubber bands are short. Components are not allowed on top of each other, except when they are located in different layers (for PCBs usually 2 layers and for ICs usually more layers). Furthermore, components are not allowed outside the circuit area.

Many tools for automatic component placement exist on the market. Force-based methods have been used for a long time, for example methods that calculate the equilibrium point (the position where the rubber band energy is minimal) and try to move the component to that point. This is done for one component at a time and special techniques are used to rearrange the placement in order to resolve conflicts if another component is already occupying the equilibrium point. These methods use force calculations, but no force simulations.

There also exist methods that, by different means of automation, strive to minimize the connection lengths between components. Worth emphasizing is that my method differs from these since it does not try to minimize connection lengths, but instead strives for force equilibrium. This gives different results than if we try to achieve the shortest possible connections.

Most tools offer interaction (editing by hand, that is) before and after the automation procedure. Some tools also have automation features that are initiated by some user interactions. However, in none of these cases the automation runs in parallel with the interaction: Every automation software for component placement known to me is fully automatic and enables no user interaction during the automation phase whatsoever.

### BRIEF SUMMARY OF THE INVENTION

My invented method makes it possible to automate component placement, but it also enables user interaction during the automation phase. This is done by performing a user-controlled rubber band force simulation of a dynamic component placement.

Automatic component placement software has been around for quite a while, but none that utilize the simulation principles that mine does.

### DETAILED DESCRIPTION OF THE INVENTION

The method means that a force simulation is performed by the computer; the connection points on components that are supposed to be interconnected are connected by virtual rubber bands. It is possible to assign different forces (spring constants) to different rubber bands, and the system can also be equipped with special rubber bands between components to achieve the desired results. When the simulation is started, the connection points are pulled together by these virtual rubber bands and the components start to move since they are affected by forces, torque etc. In the simulation, each component has a mass and thus inertia and mass moment of inertia according to well-known laws of physics. Energy loss (friction etc.) is introduced into the simulation to make the components eventually stop at suitable locations. In this configuration, most components are on top of each other (overlapping) and the rubber bands are short but usually not of minimum length.

The next step is to separate these overlapping components by introducing separating forces. The separating forces between two components are proportional to their overlap area and/or certain distances between the components and/or the component sizes. The separating forces turn and/or push the components away from each other by using several force models and methods. Similar techniques are used to prevent components from going outside the circuit area.

In order to refine the placement further, certain forces that gradually modify the component rotations are used (usually towards the nearest 90 degree rotation). As the components and the circuit area usually are rectangular in shape, proper alignment will save a lot of space.

Special force-based methods and rules are used to automatically move suitable components between the different layers of the circuit area during execution.

The user can, at any time during the simulation, control it by moving components by hand in order to make the simulation progress in the desired direction. This makes the method interactive. Since the simulation at all times is progressing towards force equilibrium, the system will be able to adapt to the changes made by the user. The various force variables involved in the simulation are dynamically controlled during execution, either by hand or automation. The simulation can also be stopped to allow for completely manual placement.

What I claim as my invention is:

1: The basic concept of using force simulations in software in order to place components on printed circuit boards and similarly to place function blocks in integrated circuits.

2: The principle of having user interaction during the very automation phase in component placement software for printed circuit boards and similarly function block placement software for integrated circuits.
I must emphasize that there's no patent claim for the specific calculations and force models used.
